(19) United States
(12) Patent Application Publication
(10) Pub. No.: US 2006/0284953 A1
(43) Pub. Date: Dec. 21, 2006

(54) Method for printing corrugated sheet

(75) Inventors: Kazuhiro Hatasa, Kasugai-shi (JP); Syunji Kato, Kasugai-shi (JP); Hiroshi Yamazaki, Kasugai-shi (JP); Shunichi Ihara, Kasugai-shi (JP)

Correspondence Address: BRINKS HOFER GILSON & LIONE, P.O. BOX 10395, CHICAGO, IL, 60610, US

(73) Assignee: Kabushiki Kaisha Isowa

(21) Appl. No.: 11/448,508

(22) Filed: Jun. 7, 2006

(30) Foreign Application Priority Data
Jun. 15, 2005 (JP) 2005-175369
May 22, 2006 (JP) 2006-141657

(51) Int. Cl. B41J 2/01

(52) U.S. Cl. 347/105

(57) ABSTRACT

A method for printing corrugated cardboard sheets is effected by transferring the corrugated cardboard sheets while jetting ink droplets from ink jet nozzles onto the corrugated cardboard sheets to form dots thereon. Said method comprises the steps of transferring the corrugated cardboard sheets one by one while at the same time sucking one flat surface of each of the corrugated cardboard sheets, and adjusting the relationship among the velocity at which the corrugated cardboard sheets are transferred, the suction force of the corrugated cardboard sheets, and the distance between the ink jet nozzle and the other corrugated surface of each of the corrugated cardboard sheets in accordance with the configuration of the said other corrugated surface and the desired DPI of dots to be formed on the said other corrugated surface. As a result, the ink droplets are jetted toward the said other corrugated surface to be printed thereon.

### FIELD OF THE INVENTION

The present invention relates to a printing method for ink-jet type printing. More particularly, the present invention relates to a method for printing a clear image on cardboard sheets having a corrugated surface.

### BACKGROUND OF THE INVENTION

As disclosed in Japanese Patent Laid-open Publication HEI10-286939A, a printing machine for printing an endless sheet by jetting ink from a fixed ink jet nozzles toward the sheet in a ink jet type has been conventionally used.

This printing machine comprises a transferring device for transferring an endless sheet, ink jet nozzles disposed at a side of the sheet to be printed to be spaced apart from the surface to be printed. The ink jet nozzles are disposed to be a predetermined distance between the tip of the ink nozzle and the surface to be printed.

According to this printing machine, by transferring the endless sheet by the transferring device, the printing is carried out by the ink droplets being caused to jet from the tip of the ink jet nozzle when the sheet crosses the ink jet heads, and to land on the surface and thus form dots thereon.

However, some technical problems arise in a case where such a printing machine is applied to corrugated cardboard sheets transferred one by one.

Firstly, as compared with the endless sheet, the corrugated cardboard sheet cut individually tends to warp more easily, so that in order to prevent such a warp, it is necessary that a number of perforated holes be provided on the conveyor belt which transfers the sheet, whereby the sheet is transferred while the sheet is being sucked toward the belt through the holes by means of suction air. In addition, a suction force having a certain amount of strength is necessary in order to prevent the sheet from being shifted relative to the belt when the sheet is transferred.

The suction air flows in a space where the ink jet nozzles are arranged through the holes located on a portion of the belt which is not covered by the sheet, that is, a gap formed between adjacent sheets in the feeding direction, and influences a trajectory the ink travels between the ink jet nozzles and the sheet during the travel of the ink droplets. As a result, the position where dots are formed on the sheet is deviated from the desired position, and dots from the same ink nozzle can overlap on the sheet, thereby causing the printing result to be worsened.

Secondly, as compared with a sheet utilized for a print-out sheet for a computer, a density of cellulose in the sheet is so coarse that the ink droplets landing on the surface of the sheet tend to penetrate into the sheet.

While on the other hand, while the retention of ink droplets on the surface of the sheet can be improved by the volume of each of the ink droplets being increased, there is a close technical relationship between the acceptable range of the volume of each of the ink droplets and that of the DPI (density per inch) of dots.

More specifically, as to the maximum volume of the ink droplet, as described above, in light of the above-described peculiar characteristics of the cardboard, it is necessary to set a volume of each of the ink droplets to be more than a certain value in order to retain the ink droplets on the corrugated surface of the sheet. On the other hand, as to the maximum volume of the ink droplet, in a case where an excessive volume of the ink droplet is jetted, the ink droplets are caused to be dispersed on the surface and thus generate a so-called satellite around the position where the ink droplets land, whereby the quality of the printing on the sheet can be worsened.

The size of dots formed on the sheet is determined mainly by the volume of each of the ink droplets, the velocity at which the sheet is transferred, and the distance between the ink jet nozzles and the surface of the sheet to be printed. While on the other hand, the size of the dots to be formed on the sheet is determined depending on the desired DPI which is selected in view of the desired printing finish.

As stated above, it is technically difficult to print the corrugated cardboard sheet which is transferred one by one so as to attain the desired printing finish while preventing the deviation of the position where the sheet is printed by the ink jet printing technique.

While on the other hand, as disclosed in Japanese Patent Laid-open Publication HEI10-128889, the conventional printing technique in which a printing die is utilized is adopted with respect to the single-faced corrugated cardboard sheet.

The single-faced cardboard consists of a core liner which is formed into a corrugated shape and a liner of a flat sheet with the core liner and the liner being attached. In a case where the bare corrugated surface of the core liner is to be printed by the conventional printing technique, the following technical problems arise.

Firstly, if the core liner is formed after the sheet to be formed into the core liner is printed, the printing image on the sheet can be smeared due to the contact between the roller and the sheet, since the corrugated sheet is formed by the sheet being passed between a pair of corrugated rollers under a predetermined nip pressure.

Secondly, it is necessary to print a surface of the core liner while the core liner is once extended to form a flat sheet.

Thirdly, it is necessary to modify the printing image in accordance with the difference of the medium to be printed, that is, the surface of the extended flat sheet and that of the corrugated core liner, so as to attain the desired printing image when the extended flat sheet is formed into the core liner again.

Fourthly, in a case where a multiple-color printing is carried out, since it is necessary to provide a printing unit for each color in the conventional printing technique, the deviation of the printing position by one printing unit from that by other printing unit can be caused.

Recently, the applications of the corrugated cardboard sheet has been broadened in a such way that attention has been paid to not only a mere corrugated cardboard box for transferring contents, but also to corrugated cardboard products whose design itself is highly evaluated, such as home furniture, gift boxes, etc.

In particular, in view of an esthetic appearance as well as an improvement of strength, a so-called meandering corrugated surface in which a waved shape is formed not only in a first direction, but also in a second direction which is perpendicular to the first direction has been focused on.

In such corrugated cardboard products, it is often necessary to effect an additional printing on the corrugated sheet already cut one by one in order to meet the situation in which a small number of sheets are printed in accordance with a large number of colored images.

In particular, in a case where the corrugated surface of the cardboard sheet is printed one by one by the ink jet printing technique, the following technical problems arises when the direction in which the corrugation advances in a cross-section which contains the corrugation is set to be along the direction in which the sheet is transferred.

Firstly, the distance between the ink jet nozzle and the surface of the corrugated sheet continuously varies between the maximum distance between the ink jet nozzle and the valley portion of the corrugated sheet and the minimum distance between the ink jet nozzle and the peak portion.

Secondly, in a case where the ink droplets land on the surface of the corrugated sheet, due to the continuous variation of the distance between the ink jet nozzle and the corrugated surface, the angle of the ink droplets relative to the surface varies in accordance with the position on the sheet where the ink droplets land. For instance, in the case of a sinusoidal corrugation, the angle is horizontal at the valley and the peak positions, whereas the angle becomes a maximum at the intermediate portion between the valley and the peak positions. This causes the size of dots and the satellite formed on the corrugated sheet to be varied in accordance with the position of the corrugated sheet.

Therefore, in order to prevent the deviation of the position where the dots are formed on the sheet, it is preferable that the velocity at which the ink droplets are jetted be a maximum and the distance between the ink jet nozzle and the corrugated sheet be a minimum. However, in order to prevent the satellite and the warp of the sheet from being generated to a certain extent, an acceptable range of the velocity as well as the distance exist.

Accordingly, in the corrugated sheet, as compared with the flat sheet of the individual corrugated cardboard sheet, the acceptable range of DPI is inevitably narrowed in order to attain the same printing finish as in the case of the flat sheet.

### SUMMARY OF THE INVENTION

In one embodiment of the printing method according to the present invention, when the cardboard sheets with corrugated surfaces are transferred toward the ink jet nozzles one by one, warping and shifting of the sheets can be prevented by sucking one of two surfaces of each of the sheets with a certain suction force. When each of the sheets crosses the ink jet nozzles, ink droplets each having a predetermined volume are jetted toward the corrugated surface, that is, the other of the two surfaces, and land on the sheet, and then dots are formed on the sheet, whereby the print image is created on the corrugated surface.

In this case, the following factors can greatly influence the clearness of the print image formed on the sheet. The first factor is that the color of the printing image is faded due to the insufficiency of the retention of each of dots due to the characteristics of the cardboard, the second factor is that dots on the corrugated surface overlap each other due to the deflection of the trajectory of the ink droplets caused by the fact that the sheet is sucked, and the third factor is that the satellites are generated upon the landing of the ink droplets.

By adjusting the relationship among the transferring velocity of the sheet, the suction force of the sheet, and the distance between the tip of each of the ink jet nozzles and the corrugated surface in accordance with the configuration of the corrugated surface including the height of the flute, the wavelength of the corrugation, etc. and DPI (dot per inch) of dots, when the cardboard sheets are printed by the ink jet type printing, even though the suction force can influence the ink droplets jetted from the tip of each of the ink jet nozzles toward the corrugated surface via the gaps between adjacent sheets in the transferring direction, the print image can be prevented from being faded by securing the retention of dots on the corrugated surface while at the same time by limiting the overlapping of dots within an acceptable range, and as a result, a clear print image with an-esthetic appearance at desired positions on the corrugated surface can be obtained.

More specifically, as to the relationship between the suction strength of the sheet and the distance between the tip of each of the ink jet nozzles and the corrugated surface, the less the distance becomes, the greater the efficiency of the printing becomes. On the other hand, the bigger the suction strength becomes, the more important it is that warping of the sheet be prevented. In addition, the retention of dots on the sheet can be impaired due to the high permeability of the cardboard, if the value of the suction force exceeds a certain value, whereby the printing image becomes fade, whereas the greater the distance between the tip of each of the ink jet nozzles and the corrugated surface becomes, although the jamming up of the sheet due to the warp of the sheet can be avoided even under a small suction force, the more the deviation of the ink droplets on the sheet from the desired positions becomes due to the fact that a flight path of each of the ink droplets between the ink jet nozzles and the corrugated surface becomes long accordingly.

As to the relationship between the transferring velocity of the sheet and the distance between the tip of each of the ink jet nozzles and the corrugated surface, a pitch between adjacent dots formed on the corrugated sheet, especially, the pitch in the widthwise direction which is perpendicular to the one in which the sheet is transferred is determined by the widthwise arrangement of the ink jet nozzles. On the other hand, in the case of the ink jet printing, after dots are formed on the corrugated surface by the ink droplets, the pitch in the transferring direction is determined by how far the sheet is advanced by the time the next ink droplet from the same ink jet nozzle lands on the surface of the sheet. Since the pitch in the transferring direction is normally set to be the same as the one in the widthwise direction, the transferring velocity of the sheet and the distance between the tip of each of the ink jet nozzles and the corrugated surface are adjusted based on the given widthwise pitch.

In particular, in a case where the corrugated cardboard sheets with corrugated surfaces are printed one by one by the ink jet printing technique, as compared with a case where a flat surface of a liner is to be printed, the length of the flight path of the ink droplets and the landing angle of the ink droplets relative to the surface vary in accordance with the positions in the transferring direction as well as the widthwise direction on the corrugated surface. Accordingly, unlike the case where the printing is carried out in order to identify contents housed in a cardboard box, the color printing needs to be clear in order to improve an esthetic appearance of the color print image on the corrugated surface, and thus it is important to adjust the relationship among the velocity at which the cardboard sheet is transferred, the distance between the tip of the ink jet nozzles and the corrugated surface, and the suction strength in order to effect a clear printing on desired positions of the sheet over an entire area of each of the cardboard sheets to be printed.

In another embodiment of the method according to the present invention, said transferring step includes a step of setting the orientation of the corrugated cardboard sheets to be transferred either to be along or to be perpendicular to the direction in which the corrugation advances in a cross section of each of the corrugated cardboard sheets.

In still another embodiment of the method according to the present invention, when each of said corrugated cardboard sheets have a meandering corrugated surface, the suction force ranges from 1 kPa to 5 kPa, the gap ranges from 1 mm to 5 mm, and the velocity at which the corrugated cardboard sheet is transferred is less than 36 m/min.

In still another embodiment of the method according to the present invention, said ink jet printing is a bubble forming thermal type so as to print the corrugated cardboard sheets under a constant velocity at which the ink droplets are jetted and a constant volume of each of the ink droplets.

### BRIEF DESCRIPTION OF THE DRAWINGS

FIG. 1 is a perspective view showing rollers for forming a meandering corrugated sheet;

FIG. 2 is a plan view showing teeth formed around the rollers shown in FIG. 1;

FIG. 3 is a schematic perspective view of the meandered corrugated sheet formed by the apparatus shown in FIG. 1;

FIG. 4 is a plan view showing a printing machine used in accordance with the present invention;

FIG. 5 is a schematic side view showing a printing machine used in accordance with the present invention;

FIG. 6 is a schematic view showing the control device of the printing machine shown in FIG. 1;

FIG. 7 is a partial plan view showing the arrangement of the ink jet nozzles;

FIG. 8 is a picture explaining the image printed on the corrugated surface of the cardboard sheets; and

FIG. 9 is a plan view showing the inner part of the suction box of the printing machine.

### DETAILED DESCRIPTION OF THE PREFERRED EMBODIMENT(S) OF THE INVENTION

A printing method of one embodiment of the present invention will be described below by which is an image is printed on a so-called core liner having a meandering corrugation.

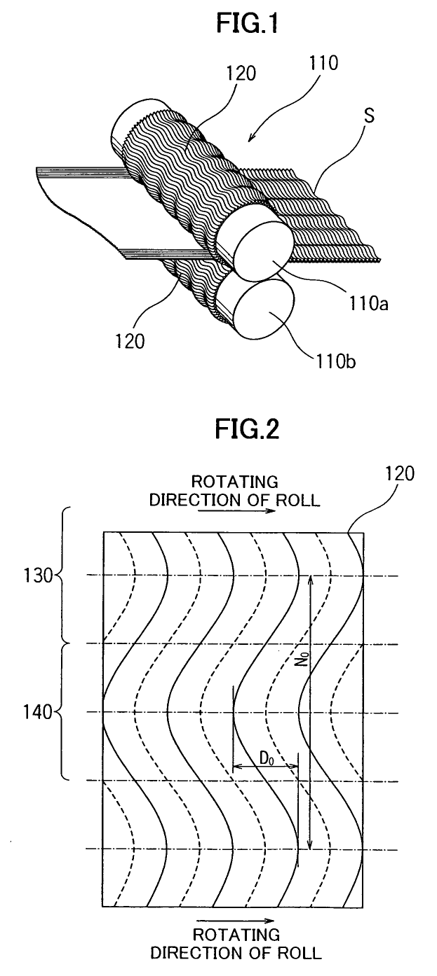

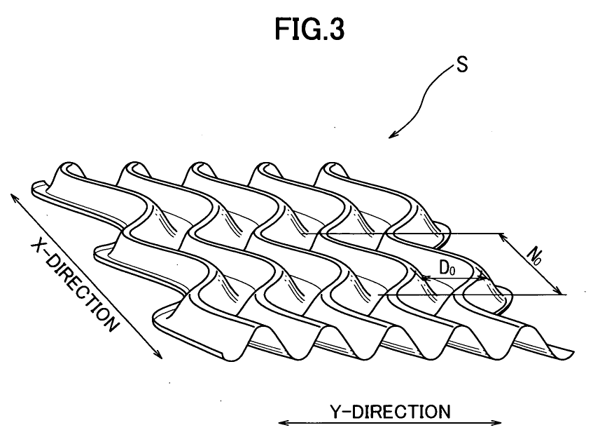

As can be seen in FIG. 1, an apparatus for manufacturing the meandering corrugated sheet includes a pair of rollers having an upper roller 110a and a lower roller 110b, and when a flat sheet is transferred between the rollers under a predetermined nip pressure, a sheet having waves extending in a width (X) direction as well as a feeding (Y) direction is formed, as shown in FIG. 3. The degree of the meandering, that is, the wave in the width (X) direction, is typically indicated by D₀/N₀ in FIG. 2.

More particularly, each of the rollers have a number of teeth 120 formed on the outer surface thereof. FIG. 2 shows an expansion plan view of the teeth 120. As can be seen in FIG. 2, the teeth 120 include front teeth 130 for forming a front wave portion of the sheet located in advance with respect to the rotation of the roller 110, and rear teeth 140 for forming a rear wave portion of the sheet located behind. An average depth of the substantial mating between the rollers in the rear teeth 140 is set to be larger than that in the front teeth 130. By such an arrangement, excessive wrinkling or deforming to its original shape of the sheet caused by the forming by means of the rollers can be prevented, whereby the sheet having an uniform and high strength wave can be formed properly, without causing any troubles, such as tearing of the sheet.

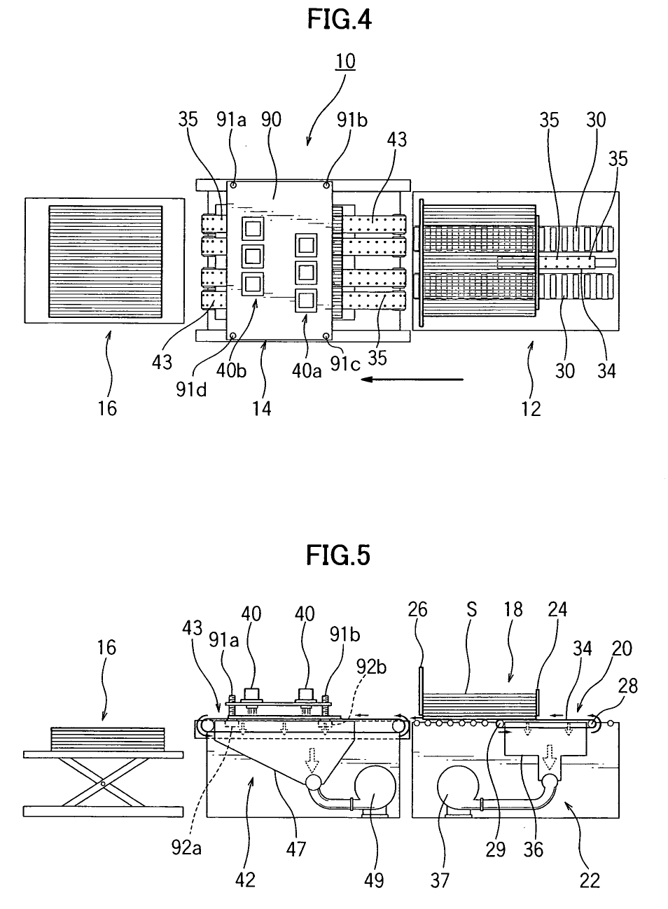

As can be seen in FIGS. 4 and 5, the printing machine 10 includes a feeding unit 12, a printing unit 14 and a stacking unit 16, and these units are aligned with respect to each other, as shown by an arrow.

The feeding unit 12 feeds cardboard sheets which are made in an upstream step of a manufacturing line, to the printing unit 14 which includes a hopper 18 for stacking the sheets, a conveyor 20 for transferring the sheets to the printing unit 14, and a suction device 22 for sucking the sheet onto the conveyor 20. The hopper 18 includes a back stop 24 located upstream in the feeding direction, and a front stop 26 located downstream and movable upwardly and downwardly, so as to stack each sheet therebetween. A gap is provided at the bottom of the front stop 26 in such a manner that the gap is larger than a thickness of the sheet and smaller than that of double stacked sheets. According to such an arrangement described above, stacked sheets can be transferred one by one to the printing unit 14 via the conveyor 20. The conveyor 20 has a pair of rollers consisting of one driving roller 28 and one idle roller 29 and an endless belt 34 disposed between the pair of rollers. The conveyor 20 is located between a pair of idle rollers 30, and the sheet is guided by the belt 34, whereby it is transferred to the printing unit 14. The belt 34 includes a number of suction holes 35 formed therethrough, when a sheet is disposed on the belt 34 with the sheet covering-the suction holes 35, the sheet is sucked onto the belt 34 via the suction device 22, whereby unwanted shift of the sheet on the belt 34 is prevented. In the suction device 22 described above, the suction device 22 is located below the belt 34 and includes a suction box 36 extending in the feeding direction of the sheet and a fan 37 for sucking an air out.

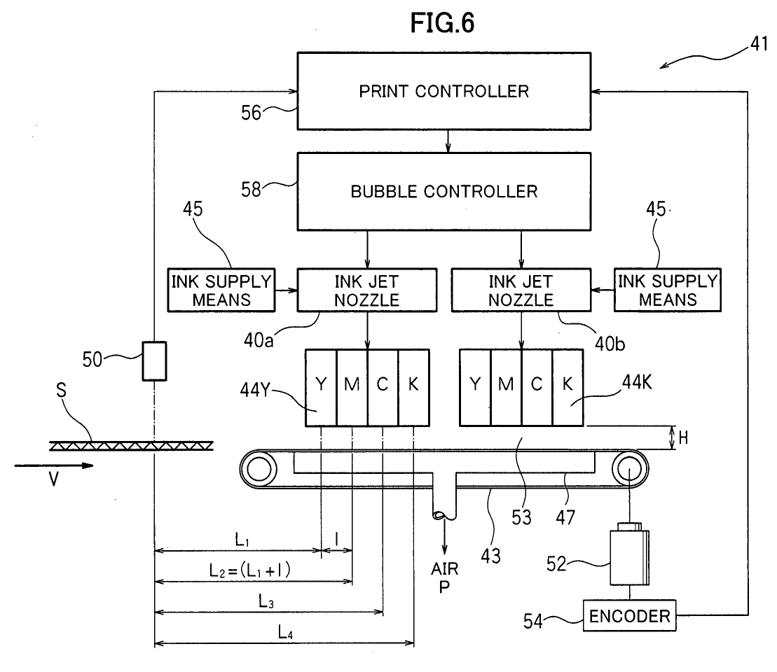

The printing unit 14 includes ink jet heads 40 located above the sheet, an ink-jet control device (see FIG. 6), a suction device 42 located below the sheet, and a conveyor 43 constructed in the same way as that of the feeding unit 12. In the ink jet heads 40, there are two sets of heads, i.e., a first set of ink jet heads 40a and a second set of ink jet heads 40b. Each of the ink jet heads includes a plurality of ink jet nozzles 44. The ink jet heads of the first and second sets of ink jet heads 40a, 40b are aligned with each other in the width direction of the sheet which is perpendicular to the feeding direction so as to cover the entire width of the sheet. Any number of heads 40 can be selected depending on the size of the sheet, however, in this embodiment, the first and second sets of the ink jet heads 40a and 40b have three heads, respectively, for a total of six.

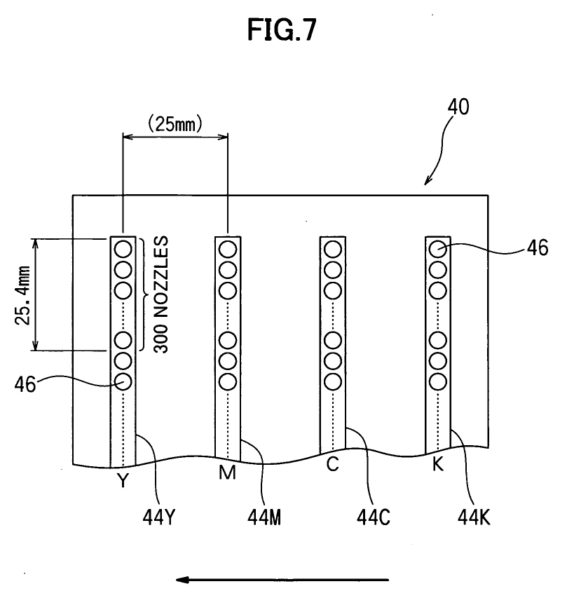

As can be seen in FIG. 7, each of the ink jet heads 40 has four groups of ink jet nozzles 44Y, 44M, 44C and 44K which respectively correspond to the colors YMCK, i.e., yellow, magenta, cyan and black. Each group includes a plurality of ink jet nozzles spaced apart, for example, 84 microns with respect to each other in the widthwise direction, and consisting of four units each unit having three hundred such nozzles. These four groups of nozzles 44Y, 44M, 44C and 44K are located in the order of YMCK from the downstream to the upstream of the sheet with being spaced apart 25 mm from each other in the feeding direction. According to such an arrangement of the ink jet nozzles 44, there is provided a printing image having a 300 dpi (density per inch) resolutions on the sheet.

More specifically, the arrangement of dots in the widthwise direction formed on the sheet by the ink droplets jetted out from the same ink jet nozzle is closely associated with the widthwise arrangement of the ink jet nozzles. In other words, the pitch between adjacent dots on the sheet is determined by gaps in the widthwise direction between the adjacent ink jet nozzles. In this case, 300 dpi of dots are formed in the widthwise direction due to the above-described arrangement of the ink jet nozzles. While on the other hand, the arrangement of dots in the feeding direction is determined by the value which is calculated by multiplying a summation of a time period for the ink droplets to travel between the ink jet nozzle and the surface of the sheet and that for the bubble to be generated in the ink jet nozzle by the velocity at which the sheet is transferred. The traveling time period and the bubble forming time period are totally dependent on the capability of the thermal type ink jet printing technique.

In view of the printing finish, dpi of dots in the widthwise direction is normally set to be identical to that in the feeding direction. Accordingly, the feeding velocity of the sheet may be determined so as to make the dpi in the feeding direction match that in the widthwise direction which is determined by the widthwise arrangement of the ink jet nozzles. In a case where the cardboard sheet is printed by the ink jet printing, the preferable dpi of dots is between 300 dpi to 900 dpi in order to obtain the clear print image as well as to maintain the efficiency of the printing.

Therefore, when the sheet is being fed, the entire width of the sheet is covered by all the ink jet heads 40a, 40b and the ink jet nozzles 44 of the ink jet heads 40 are controlled by the ink-jet control device 41 to create printing image by YMCK dots formed on the surface.

More particularly, each of the ink jet nozzles 44 is caused to eject the ink supplied by respective ink reservoirs 45 (see FIG. 6) from openings 46 onto the surface S of the sheet. To this end, an electrical potential is applied at the bottom of the ink jet nozzles 44 to cause heated bubbles to be formed in the ink jet nozzles 44 to cause the ink droplets to be emitted from the tip thereof. The volume of each of the ink droplets is about 150 pico-liter, for instance, and the electrical potential is adjusted so as to constantly jet the ink droplet with such a volume at a constant jet speed.

The construction of the suction device 42 and the transfer conveyor 43 is similar to that of the feeding unit 12, as can be seen in FIGS. 4 and 5. The suction device 42 includes a suction box 47 and a fan 49 disposed below the conveyor 43. The transfer conveyor 43 includes four rows of conveyors spaced apart from each other in the widthwise direction, each of which has the suction holes 35 for applying a suction force to the sheet moving toward the printing unit 14. Also, the suction air by the suction device 42 will flow from the lower side of the sheet to the upper side of the sheet through the holes 35 located in the gap between the adjacent sheets in the feeding direction and thus to a space 53 between the ink jet heads 40 and the surface S of the transferred sheet. This causes the ink droplets emitted from the ink jet nozzles 44 toward the surface of the sheet to be deflected. The suction force is preferably from 1 kPa to 5 kPa.

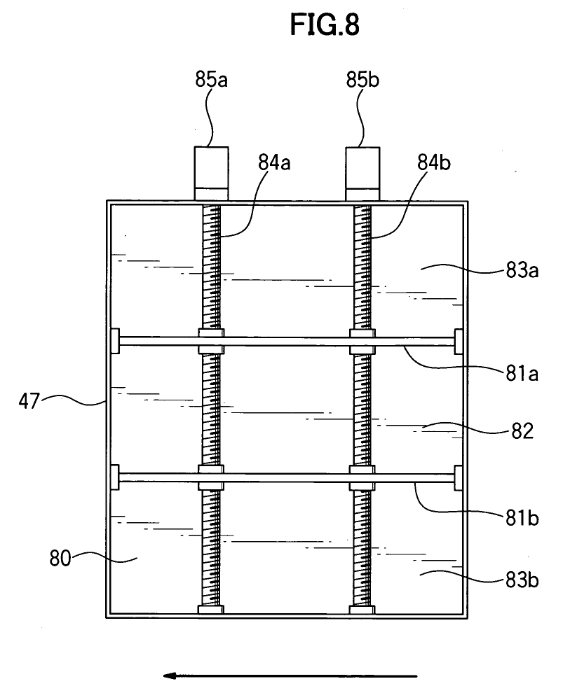

As can be seen in FIGS. 4 and 5, the suction box 47 has a width large enough to cover all the suction holes 35 and a length longer than the sheet, and has a rectangular opening facing the conveyor 43. As shown in FIG. 8, provided within the suction box 47 are a pair of dampers 81a, 81b each extending in the feeding direction of the sheet, as shown by an arrow, which creates a separated suction area 82 and non-suction areas 83a and 83b. The pair of dampers 81a, 81b are supported by a pair of threaded shafts 84a and 84b, respectively, which are rotated by damper adjusting motors 85a and 85b so as to move the dampers 81a, 81b in the width direction whereby the width of the suction area 82 can be adjusted in accordance with the width of the sheet.

As can be seen in FIG. 6, the ink-jet control device includes a sheet position sensor 50, an encoder 54 mounted on a conveyor drive shaft 52, a processor 56 which receives signals from the sheet position sensor 50 and the encoder 54, and a bubble control device 58 which receives signals from the processor 56 and transmits signals to the ink jet nozzles.

The operation of the above described printing machine 10 will be explained below.

Firstly, whether each of the corrugated sheets cut individually is transferred in such a way that the direction in which the corrugation advances in a cross section of the sheet is set to be along the direction in which the sheet is transferred, or to be perpendicular to said transferring direction, is selected. In the former selection, the distance between the tip of each of the ink jet nozzles and the corrugated surface at a widthwise position of the sheet varies as the sheet is transferred, since the peak and valley portions of the corrugation are passed below the ink jet nozzles repeatedly, while in the latter selection, such a distance is constant. The following description is based on the former selection.

Then, the rotation of the motor 92 is adjusted in accordance with the thickness of the sheet, whereby the distance H between the tips of the ink jet nozzles 44 and the printing surface is adjusted, for example, from 1.0 mm to 1.5 mm. Next, the rotation of the motor 85 is adjusted in accordance with the width of the sheet, whereby the location of the dampers 81a, 81b and thus the width of the suction area 82 are adjusted in such a way that the entire width of the sheet can be sucked.

Also, data of feeding distances L1, L2, L3 and L4 regarding distances from the sheet position sensor 50 to the ink jet heads 40 and data of sheet feeding speed V are stored in the processor 56. When the sheet is fed one by one from the feeding unit 12 to the printing unit 14, the lower surface of the sheet is suctioned by the suction device 22, whereby the warp of the sheet is removed, and then the sheet goes through immediately below the ink jet heads 40 without causing the shift of the sheet relative to the conveyor belt. When the sheet passes through the sheet position sensor 50, a detection signal is transmitted to the processor 56. When the sheet position sensor 50 detects the front end of the sheet which is being transferred, the detecting signal is transmitted to the processor 56. At the same time, the encoder 54 starts counting the rotations of the motor 42, and a rotation count signal is transmitted to the processor 56. The processor 56 converts the rotation count signal to the distance data using the sheet feeding speed data, and when the converted distance data matches the predetermined data, transmits a signal to the bubble control device 58. The bubble control device 58 transmits a control signal to the ink jet heads 40 so as to cause the ink to be jetted out from the nozzles 44 toward the surface S of the sheet, thereby causing the ink to land on the surface S to form a number of dots on the surface S, whereby the printing image with the desired colors and shape is created with YMCK color dots.

More specifically, each of the ink droplets with a certain volume is jetted out from the tip of each of the ink jet nozzles 44 toward the meandering corrugated surface S by applying an electric potential of the thermal type so as to form a bubble with a corresponding volume.

By adjusting the relationship among the transferring velocity of the sheet, the suction force of the sheet, and the distance between the tip of each of the ink jet nozzles 44 and the meandering corrugated surface in accordance with the configuration of the meandering corrugated surface S including the height of the flute, the wavelength of the corrugation, etc. and DPI (dot per inch) of dots, when the cardboard sheets are printed by the ink jet type printing, even though the suction force can influence the ink droplets jetted from the tip of each of the ink jet nozzles 44 toward the meandering corrugated surface via the gaps between adjacent sheets in the transferring direction, the print image can be prevented from being faded by securing the retention of dots on the meandering corrugated surface while at the same time limiting the overlapping of dots within an acceptable range, and as a result, a clear print image with an esthetic appearance at desired positions on the meandering corrugated surface S can be obtained.

In particular, in a case where the ink droplets land on the meandering corrugated surface S, the landing angle of the ink droplets relative to the meandering corrugated surface S varies in accordance with which position in the transferring direction between the peak and valley portions of the corrugation as well as which position in the widthwise direction the position to be printed in question is located at, whereby the shape of dots formed on the meandering corrugated surface S is changed. It is necessary to adjust the relationship among the velocity at which the sheet is transferred, the suction force of the sheet, and the distance between the tip of each of the ink jet nozzles and the meandering corrugated surface S in order to limit such a change within an acceptable range.

The inventor has made a great effort through many trial-and-error experiments and finally found out that in a case where each of the meandering corrugated sheets transferred one by one is printed by the thermal type ink jet printing while at the same time it is sucked in order to prevent the warping and the shifting of the sheets, a clear printing image with dpi of dots being between 300 dpi and 900 dpi can be obtained on desired positions of the meandering corrugated sheets despite the fact that the landing angle of the ink droplets varies and formed dots tend to penetrate into the sheet, by setting the suction force in a range from 1 kPa to 5 kPa, the distance between the ink jet nozzles and the surface ranging from 1 mm to 5 mm, and the transferring velocity of the sheets to less than 36 m/min, and adjusting the relationship among said velocity, said suction force, and said distance.

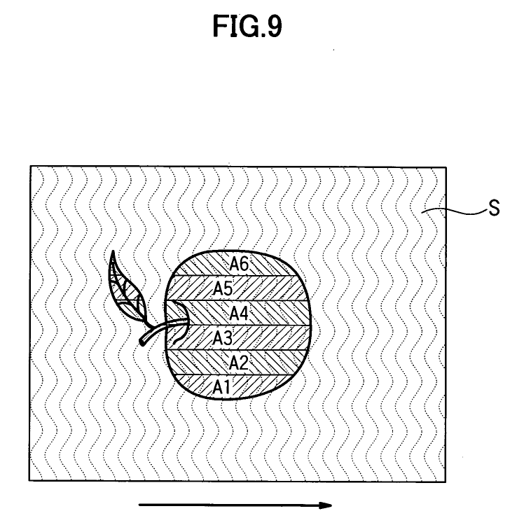

The printing operation described above is carried out for the first set of ink jet heads 40a and the second set of ink jet heads 40b. More particularly, the printing areas A2, A4 and A6 are printed via the first set of ink jet heads 40a, and thereafter the printing areas A1, A3 and A5 are printed via the second set of ink jet heads 40b. FIG. 9 shows an example of a printed image.

The printed sheet is transferred to the stacking unit 16 and stacked therein. The printing operation of the printing machine is now completed.

As described above, the meandering corrugated cardboard sheets have multiple applications, such as packages of food, trays, bookshelves, etc., due to an esthetic appearance derived from a synergistic effect, that is, the combination of the novelty of a shape and a pattern of the meandering corrugation and that of the colorful and clear print image on the surface.

Especially, when the corrugated surface of the core liner is printed in multiple colors, conventionally, since the core liner which already has been printed was passed between the pair of corrugated rollers under a nip pressure, the print image which has been provided on the surface in advance can be distorted by the width of the core liner being shrunken, or the print image can be smeared by the sheet with the print image being passed between the rollers.

While on the other hand, in the ink jet printing method in the present invention, since a multiple-color print image can be created even on the meandering corrugated surface of the cardboard sheet in a non-contact manner, the desired printing can be carried out after the corrugated sheet is formed and thus the problems mentioned above can be eliminated.

The above described embodiment can be modified within the spirit and scope of the invention, which those skilled in the art will recognize. For example, single faced sheets were used in the embodiment described above, however, double faced sheets can be printed in the same way. Also, a plurality of ink jet heads were utilized in the embodiment described above, but in other embodiments, a single ink jet head can be utilized depending on the width of the sheet. Furthermore, a combination of transfer rollers and evacuating boxes can be utilized instead of suction holes formed on the transfer belt.

What is claimed is:

1. A method for printing corrugated cardboard sheets by transferring the corrugated cardboard sheets while jetting ink droplets from ink jet nozzles onto the corrugated cardboard sheets to form dots thereon, characterized in that said method comprises the steps of:
transferring the corrugated cardboard sheets one by one while at the same time sucking one flat surface of each of the corrugated cardboard sheets; and
jetting the ink droplets toward the other corrugated surface to be printed thereon.

2. The method as recited in claim 1 further comprises the step of:
adjusting the relationship among the velocity at which the corrugated cardboard sheets are transferred, the suction force of the corrugated cardboard sheets, and the distance between the ink jet nozzle and the other corrugated surface of each of the corrugated cardboard sheets in accordance with the configuration of the said other corrugated surface and the desired DPI of dots to be formed on the said other corrugated surface.

3. The method as recited in claim 1, wherein said transferring step includes a step of setting the orientation of the corrugated cardboard sheets to be transferred either to be along or to be perpendicular to the direction in which the corrugation advances in a cross section of each of the corrugated cardboard sheets.

4. The method as recited in claim 1, wherein when each of said corrugated cardboard sheets have a meandering corrugated surface, the suction force ranges from 1 kPa to 5 kPa, the gap ranges from 1 mm to 5 mm, and the velocity at which the corrugated cardboard sheet is transferred is less than 36 m/min.

5. The method as recited in claim 1, wherein said ink jet printing is a bubble forming thermal type so as to print the corrugated cardboard sheets under a constant velocity at which the ink droplets are jetted and a constant volume of each of the ink droplets.
